(19) United States
(12) Patent Application Publication
(10) Pub. No.: US 2012/0319910 A1
(43) Pub. Date: Dec. 20, 2012

(54) CORRUGATED HORN FOR INCREASED POWER CAPTURED BY ILLUMINATED APERTURE

(75) Inventor: Martin GIMERSKY, Bratislava (SK)

(73) Assignee: ASTRIUM LTD., Hampshire (GB)

(21) Appl. No.: 13/492,178

(22) Filed: Jun. 8, 2012

(30) Foreign Application Priority Data
Jun. 15, 2011 (EP) 11004875.8-2220

(51) Int. Cl. H01Q 13/02; H01P 11/00

(52) U.S. Cl. 343/786; 29/600

(57) ABSTRACT

Feed horn transmitting and receiving signals and method of making. Feed horn includes a throat section structured to convert a TE₁₁ mode to an HE₁₁ mode, an aperture section positioned opposite throat section, and a multiple-corrugation transition section connected to throat section and having a plurality of radial corrugations that substantially widen an interior of the feed horn from throat section toward aperture section. Throat section, aperture section and transition section are arranged to have a same axis of symmetry. The plurality of corrugations are dimensioned relative to one another to alter a mode content of a signal so that a more co-polarized power is radiated within a predetermined solid angle of a cone in at least one frequency band as compared to a reference feed horn employing a substantially pure HE₁₁ mode in its aperture and providing a same illumination taper at a same conical half-angle at same frequencies.

### CROSS-REFERENCE TO RELATED APPLICATIONS

The present application claims priority under 35 U.S.C. § 119(a) of European Patent Application No. 11 004 875.8-2220 filed Jun. 15, 2011, the disclosure of which is expressly incorporated by reference herein in its entirety.

### BACKGROUND OF THE INVENTION

1. Field of the Invention

The present invention relates to horn antennas and, more particularly, to radially-corrugated horns for illumination of reflector and lens antennas.

2. Discussion of Background Information

A conventional corrugated horn with radial corrugations, such as the one described in U.S. Pat. No. 4,472,721 granted on Sep. 18, 1984 to Morz et al. and the ones in “Characteristics of a broadband microwave corrugated feed: A comparison between theory and experiment” (Bell System Technical Journal, vol. 56, no. 6, pp. 869-889, July-August 1977) by Dragone or described in the publication “Design of corrugated horns: a primer” (IEEE Antennas and Propagation Magazine, vol. 47, issue 2, pp. 76-84, April 2005) by Granet and James, consists of a corrugated mode converter and a corrugated flare section. In the case of a circular cross-section of the corrugated horn, the mode converter converts the dominant (TE₁₁) mode of the feeding circular waveguide to the substantially pure HE₁₁ mode. The flare section then supports the generated HE₁₁ mode as it propagates from the mode converter to the horn aperture. While the mode converter can be one of several types—such as the variable-depth-slot, ring-loaded-slot or variable-pitch-to-width-slot—the flare section employs corrugations with substantially constant widths, depths and spacings.

More recent prior-art patents relating to corrugated horns with radial corrugations refer to high aperture efficiency, thus also high power gain, of the horns. For example, US Patent Application Publication 2002/0167453 A1 by Kung et al., published on Nov. 14, 2002, describes one such high-aperture-efficiency horn that yields a flat-top secondary-pattern beam when used to illuminate a reflector. U.S. Pat. No. 6,522,306 B1 granted on Feb. 18, 2003 to Parrikar et al. describes a hybrid horn, consisting of corrugations and a smooth-walled flare section, producing high power gain and lower secondary-pattern sidelobes.

Corrugated horns are wideband devices. They can be designed for supreme co-polarized beam integrity, low cross-polarization and good impedance match over one wide frequency band or several sub-bands contained within that wide band. However, when the horn flare angles are relatively small and the corrugations are machined radially (i.e., perpendicularly to the horn central axis), as opposed to perpendicularly to the metallic walls of the horn flares, the horns' co-polarized radiation patterns are frequency dependent. This is illustrated in FIGS. 1 and 2 where a conventional corrugated horn 1 depicted in a cross-section in FIG. 1 yields the far-field radiation patterns 11 presented in FIG. 2. In FIG. 1, a throat section 110, constituting a TE₁₁-to-HE₁₁ mode converter, of the horn 1 has in total four corrugations 111. The flare section 120 comprises thirteen (13) corrugations 121 and is connected to the throat section 110. The diameter of the corrugations 121 expands from the throat section towards the horn aperture 130. In FIG. 2, the co-polarized pattern 13 at a higher frequency (30.0 GHz) features a power gain at 0 degrees higher than the co-polarized pattern 12 at a lower frequency (20.2 GHz); similarly, the co-polarized pattern 13 at a higher frequency has the beam (main lobe) narrower that the co-polarized pattern 12 at a lower frequency. When such a horn is employed to illuminate an aperture 4, e.g., of a lens or reflector 3 depicted in FIG. 6, the resulting secondary radiation patterns at the two frequencies are uneven—for example, a reflector/lens illuminated by a corrugated horn that was designed for optimal reflector/lens radiation performance at a lower frequency will exhibit suboptimal radiation performance at a higher frequency and vice versa.

### SUMMARY OF THE EMBODIMENTS

Embodiments of the present invention provide a radially-corrugated horn that obviates the above-noted disadvantage of the conventional radially-corrugated horn by eliminating or reducing frequency dependence of the horn's radiation patterns.

Accordingly, embodiments provide a feed horn for transmitting and receiving signals. The horn comprises a throat section for converting the TE₁₁ mode to the HE₁₁ mode, an aperture section opposite to the throat section, and a multiple-corrugation transition section connected to the throat section. The transition section has a plurality of radial corrugations that substantially widen the feed horn from the throat section toward the aperture section and the throat section, the aperture section and the transition section have a same axis of symmetry. The plurality of corrugations are dimensioned relative to one another to alter the mode content of the signal so that the feed horn radiates more co-polarized power within a predetermined solid angle of a cone in at least one frequency band than the feed horn employing the substantially pure HE₁₁ mode in its aperture and providing the same illumination taper at the same conical half-angle at the same frequencies.

It has been found that by adjusting the geometrical dimensions of the corrugations of the horn's flare section, the signal can be altered such that it is composed of the HE₁₁ mode and a number of additional, higher-order modes. With the higher-order modes in the horn aperture, more co-polarized power within the predetermined angle of a cone can be radiated. The optimal mode-mix depends on the desired amount of the co-polarized power within a predetermined solid angle of the cone and the horn aperture diameter. As a result the radial corrugations provide effective control over the radiation patterns of a plurality of signals comprising a plurality of communication frequency bands.

The throat section of the horn converts the dominant (TE₁₁) mode of the feeding circular waveguide to the substantially pure HE₁₁ mode. However, as the arrangement of corrugations forming the horn flare section widens, it becomes possible to excite higher-order field modes: the bigger the flare-section diameter, the higher the order of the field modes that can be excited and propagated toward the horn aperture, i.e., individual higher-order modes are excited at different locations along the horn length. Using theoretical analysis and/or mathematical optimization, the profile of horn corrugations is specially designed or tuned to excite the higher-order modes, in addition to the HE₁₁ mode, that increase to a desired level the co-polarized power radiated within the solid angle of the cone subtended by the aperture (e.g., of a lens or reflector) that the horn illuminates, while providing a desired aperture-edge illumination taper, thus also a desired secondary-pattern sidelobe control. The corrugations in the horn flare section are dimensioned so that the higher-order modes required to achieve the desired effect are excited with the needed amplitudes and phases and that the corrugations that follow support the excited modes, so that the modes can propagate to the horn aperture. Bound states of electromagnetic energy anywhere within the horn over the operating frequency band(s) of the horn are avoided. The bound states are narrowband by nature and greatly disturb the input impedance and radiation patterns of the horn at the affected frequencies.

There is no one universally optimal composition of field modes, described by the amplitudes and phases of the individual modes, in the aperture of the horn in accordance with the principles of the present invention. In any application, the optimal modal composition primarily depends on the horn aperture diameter, the desired aperture-edge illumination taper and the desired amount of the co-polarized power within a predetermined solid angle of a cone. Other performance parameters, such as the maximal acceptable level of cross-polarization, may also have to be factored into the determination of the optimal modal composition.

There is no single feature (shape or arrangement of corrugations) that makes the horn in accordance with the principles of the present invention achieve the increase of captured co-polarized power. The horn corrugations strongly interact with one another, whereby the interactions (mutual couplings) extend beyond immediately adjacent corrugations. Consequently, it is the global action of the entire flare section, with a multitude of complex mutual couplings within, that achieves the described effect.

The present corrugated horn retains the high polarization purity and the wideband input-impedance and radiation-pattern characteristics of the conventional corrugated horn. In addition, it significantly reduces the position drift of the conventional corrugated horn's phase center over the operating frequency band(s).

The corrugated horn does not feature high aperture efficiency (thus also high power gain), which is beneficial for multiple-beam antennas, as disclosed in the Kung et al. and Parrikar et al. references. Instead, by increasing the co-polarized power captured by the illuminated aperture, the horn is more advantageous in single-beam antennas.

According to a further improved embodiment, the feed horn further comprises an input-impedance matching section coupled between the feed horn and a feeding waveguide, said section matching the input impedance of the feed horn through non-reflective direct signal propagation in the at least one operating frequency band.

According to a further improved embodiment, the feed horn is free of bound states of electromagnetic energy within the at least one operating frequency band.

According to a further improved embodiment, the overall locus of feed horn's phase center positions over the at least one operating frequency band spans a shorter distance than that of the horn employing the substantially pure HE₁₁ mode in its aperture.

According to a further improved embodiment, the feed horn is adapted to produce low cross-polarization in at least one operating frequency band.

The invention has a number of advantages:

It is an advantage of the invention that the radially-corrugated horn illuminates an aperture in such a way that the illuminated aperture captures more co-polarized power than when illuminated by the conventional radially-corrugated horn providing the same aperture-edge illumination taper.

Furthermore, the radially-corrugated horn enables more control over the peak co-polarized radiation gain values at lower and/or higher frequencies than the conventional radially-corrugated horn.

Yet another advantage of the present invention is that the radially-corrugated horn enables more control over the co-polarized radiation beam (main lobe) shape at lower and/or higher frequencies than the conventional radially-corrugated horn.

Still another advantage of the present invention is that the radially-corrugated horn provides excellent polarization purity.

Furthermore, the radially-corrugated horn reduces position drift of the horn's phase center over the operating frequency band(s).

Finally, the radially-corrugated horn has an excellent input-impedance match.

Embodiments of the instant invention are directed to a feed horn for transmitting and receiving signals. The feed horn includes a throat section structured to convert a TE₁₁ mode to an HE₁₁ mode, an aperture section positioned opposite the throat section, and a multiple-corrugation transition section connected to the throat section and having a plurality of radial corrugations that substantially widen an interior of the feed horn from the throat section toward the aperture section. The throat section, the aperture section and the transition section are arranged to have a same axis of symmetry. The plurality of corrugations are dimensioned relative to one another to alter a mode content of a signal so that a more co-polarized power is radiated within a predetermined solid angle of a cone in at least one frequency band as compared to a reference feed horn employing a substantially pure HE₁₁ mode in its aperture and providing a same illumination taper at a same conical half-angle at same frequencies.

According to embodiments, the feed horn can include an input-impedance matching section coupled between a feed horn input and a feeding waveguide. The input-impedance matching section may be structured to match an input impedance of the feed horn through non-reflective direct signal propagation in the at least one operating frequency band.

In accordance with other embodiments, the feed horn can be structured to be free of bound states of electromagnetic energy within the at least one operating frequency band.

According to still other embodiments of the invention, an overall locus of phase center positions over the at least one operating frequency band may span a shorter distance than that of the reference feed horn employing the substantially pure HE₁₁ mode in its aperture.

Still further, the feed horn can be structured and arranged to produce low cross-polarization in the at least one operating frequency band.

In accordance with other embodiments, the interior of the feed horn can have a generally step-wise contour. Alternatively, the interior of the feed horn may flare outwardly from the throat section to the aperture section in a generally step-wise manner.

Moreover, widths of a plurality of the corrugations in the direction of the symmetry axis may be dissimilar.

Embodiments of the invention are directed to a method for forming a feed horn. The method include connecting a multiple-corrugation transition section to a throat section and to an aperture section positioned opposite the throat section, the multiple-corrugation transition section having a plurality of radial corrugations that substantially widen an interior of the feed horn from the throat section toward the aperture section. The method also includes dimensioning the corrugations of the multiple-corrugation transition section relative to one another to alter a mode content of a signal so that the formed feed horn radiates more co-polarized power within a predetermined solid angle of a cone in at least one frequency band as compared to a reference feed horn employing a substantially pure HE₁₁ mode in its aperture and providing a same illumination taper at a same conical half-angle at the same frequencies.

According to embodiments, the method may include structuring the feed horn to be free of bound states of electromagnetic energy within the at least one operating frequency band.

In accordance with other embodiments of the invention, the method may include structuring the feed horn so that an overall locus of phase center positions over the at least one operating frequency band spans a shorter distance than that of the reference feed horn employing the substantially pure HE11 mode in its aperture.

Moreover, the method can also include structuring the feed horn to produce low cross-polarization in the at least one operating frequency band.

According to further embodiments, the interior of the feed horn may be shaped with a generally step-wise contour.

In accordance with still further embodiments, the interior of the feed horn may be shaped to flare outwardly from the throat section to the aperture section in a generally step-wise manner.

According to other embodiments, the throat section may be structured for converting a TE₁₁ mode to an HE₁₁ mode.

In accordance with still yet other embodiments of the present invention, widths of a plurality of the corrugations in the direction of the symmetry axis are formed to be dissimilar.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a longitudinal cross-sectional view along the central axis through a conventional corrugated horn with radial corrugations;

FIG. 2 shows a plot of far-field co-polarized radiation patterns of a conventional corrugated horn of FIG. 1—solid line: 20.2 GHz; dashed line: 30.0 GHz;

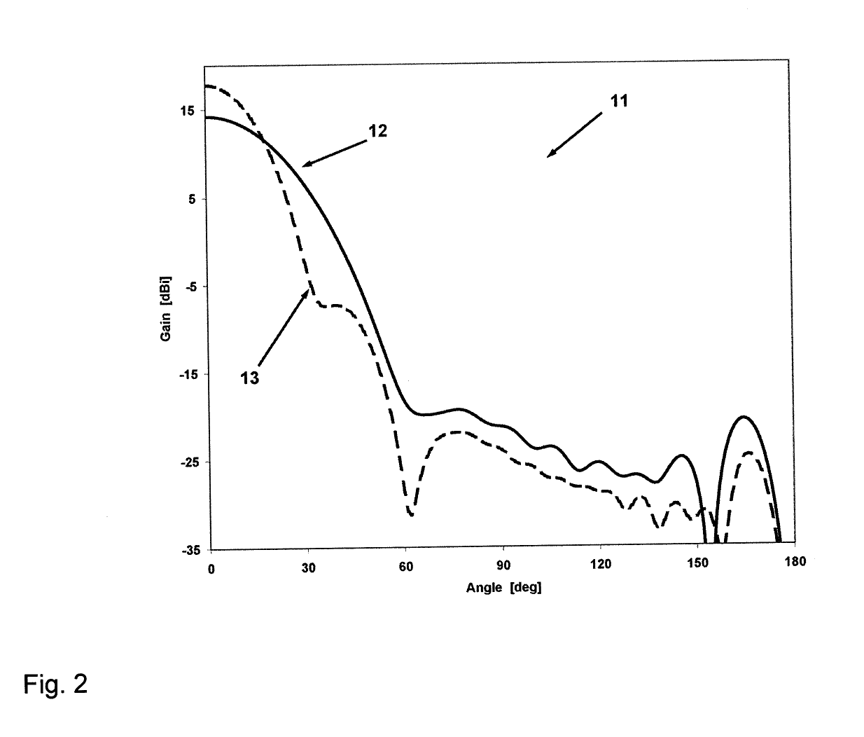

FIG. 3 shows a perspective view of an exemplary corrugated horn in accordance with the principles of the present invention;

FIG. 4 is the longitudinal cross-sectional view along the central axis through an exemplary corrugated horn in accordance with the principles of the present invention;

FIG. 5 shows a table with the full set of dimensions of the exemplary corrugated horn, shown in FIGS. 3 and 4;

FIG. 6 is a perspective view of a horn illuminating a reflector;

FIG. 7 is a plot of far-field co-polarized radiation patterns of corrugated horns at 20.2 GHz—solid line: the exemplary corrugated horn in accordance with the principles of the present invention of FIGS. 3 and 4; dashed line: the conventional corrugated horn of FIG. 1; and

FIG. 8 is a plot of far-field co-polarized radiation patterns of corrugated horns at 30.0 GHz—solid line: the exemplary corrugated horn in accordance with the principles of the present invention of FIGS. 3 and 4; dashed line: the conventional corrugated horn of FIG. 1.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

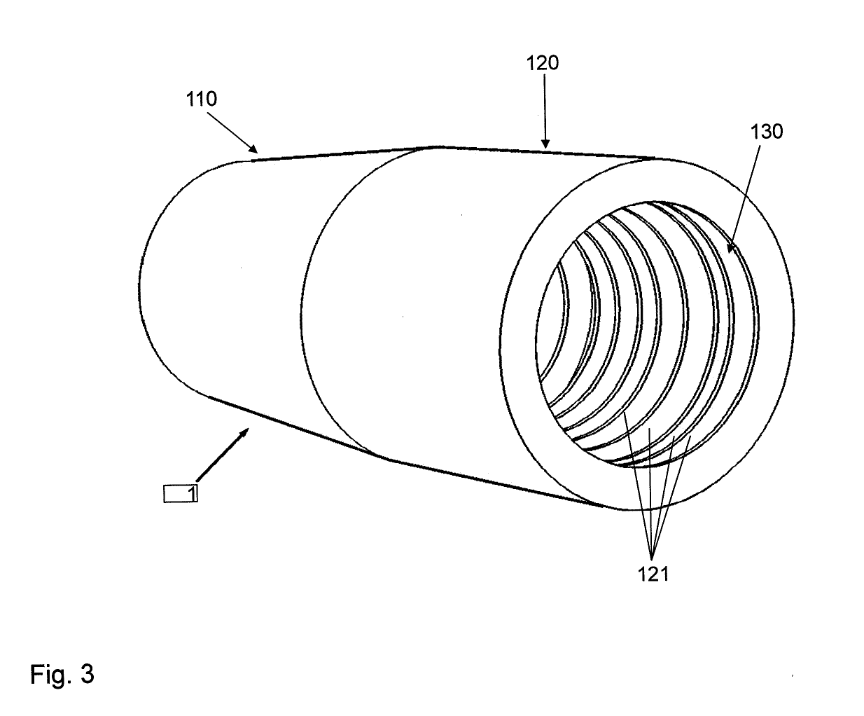

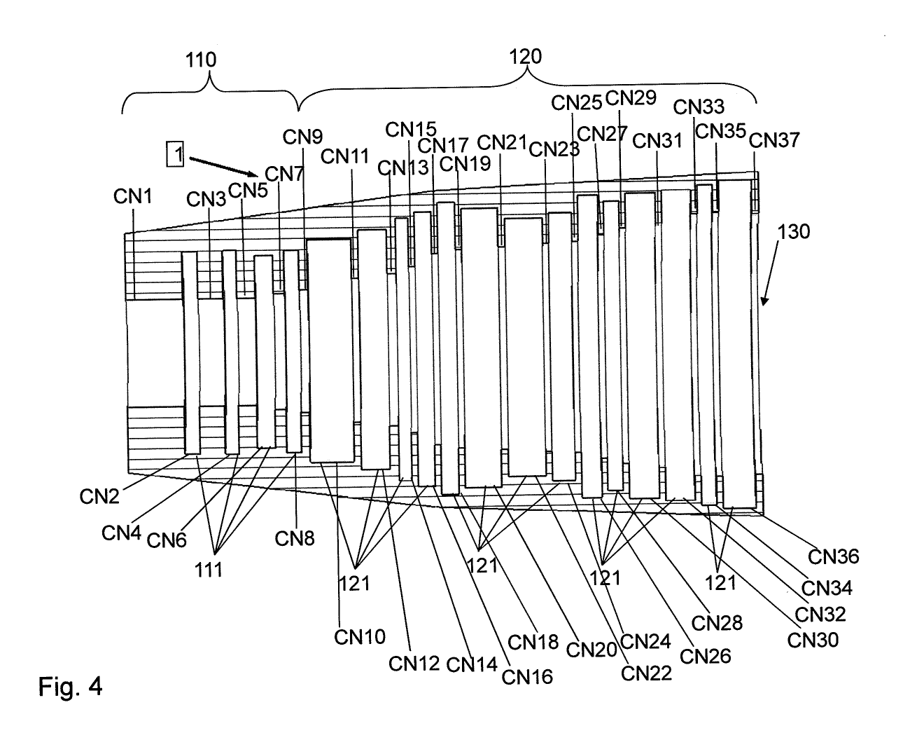

FIG. 3 shows a feed horn 1 for transmitting and receiving signals according to the invention in a perspective view and FIG. 4 shows feed horn 1 in a cross-sectional view along a central axis. The feed horn 1 comprises a throat section 110 having four corrugations 111 for converting the TE₁₁ mode to the HE₁₁ mode. An aperture section 130 is provided opposite the throat section 110. A multiple-corrugation transition section 120 representing the horn's flare section is connected to the throat section 110. The flare section 120 has a number of radial corrugations 121, e.g., fourteen (14) corrugations, that substantially widen the feed horn 1 from the throat section 110 toward the aperture section 130. The throat section 110, the aperture section 130 and the flare section 120 have a same axis of symmetry (not shown in FIGS. 3 and 4). The corrugations 121 of the flare section 120 are dimensioned relative to one another to alter the mode content of the signal so that the feed horn 1 radiates more co-polarized power within a predetermined solid angle of a cone in at least one frequency band than the feed horn employing the substantially pure HE₁₁ mode in its aperture and providing the same illumination taper at the same conical half-angle at the same frequencies.

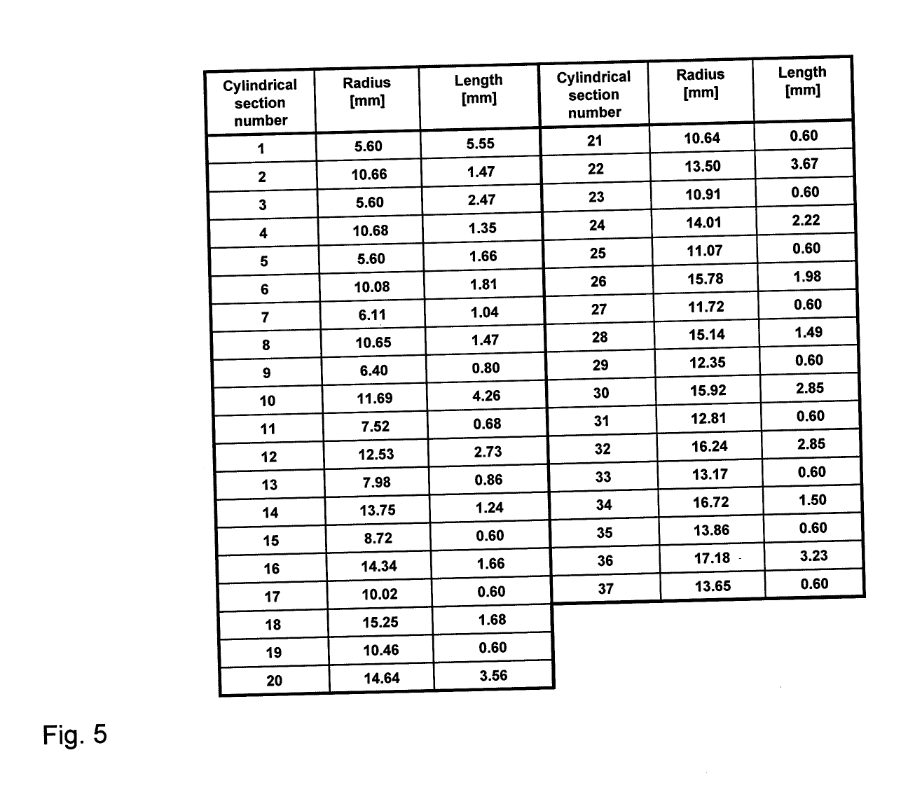

This behavior is achieved solely by adjusting the geometrical dimensions of the corrugations of the horn's flare section. In FIG. 5 a table with the full set of dimensions of the exemplary corrugated horn, shown in FIGS. 3 and 4, is illustrated. The cylindrical section number of this table is denoted with CNi, where i=1 to 37, in FIG. 4. In a feed horn as described, the signal can be altered such that it is composed of the HE₁₁ mode and a number of additional, higher-order modes. With the higher-order modes in the horn aperture, more co-polarized power within the predetermined angle of a cone can be radiated. The optimal mode-mix depends on the desired amount of the co-polarized power within a predetermined solid angle of the cone and the horn aperture diameter. As a result, the radial corrugations provide effective control over the radiation patterns of a plurality of signals comprising a plurality of communication frequency bands.

The throat section 110 of the horn converts the dominant (TE₁₁) mode of the feeding circular waveguide to the substantially pure HE₁₁ mode. However, as the arrangement of corrugations forming the horn flare section widens, it becomes possible to excite higher-order field modes: the bigger the flare-section diameter, the higher the order of the field modes that can be excited and propagated toward the horn aperture, i.e., individual higher-order modes are excited at different locations along the horn length.

Using theoretical analysis and/or mathematical optimization, the profile of horn corrugations can be specially designed or tuned to excite the higher-order modes, in addition to the HE₁₁ mode, that increase to a desired level the co-polarized power radiated within the solid angle of the cone subtended by the aperture (e.g., of a lens or reflector) that the horn illuminates, while providing a desired aperture-edge illumination taper, thus also a desired secondary-pattern sidelobe control.

The corrugations in the horn flare section are dimensioned so that the higher-order modes required to achieve the desired effect are excited with the needed amplitudes and phases and that the corrugations that follow support the excited modes, so that the modes can propagate to the horn aperture. Bound states of electromagnetic energy anywhere within the horn over the operating frequency band(s) of the horn are avoided. The bound states are narrowband by nature and greatly disturb the input impedance and radiation patterns of the horn at the affected frequencies.

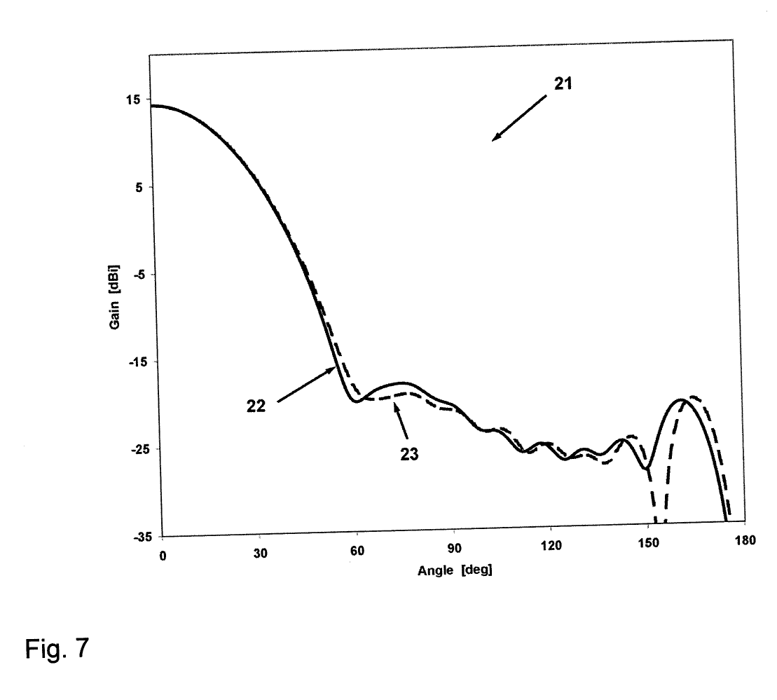

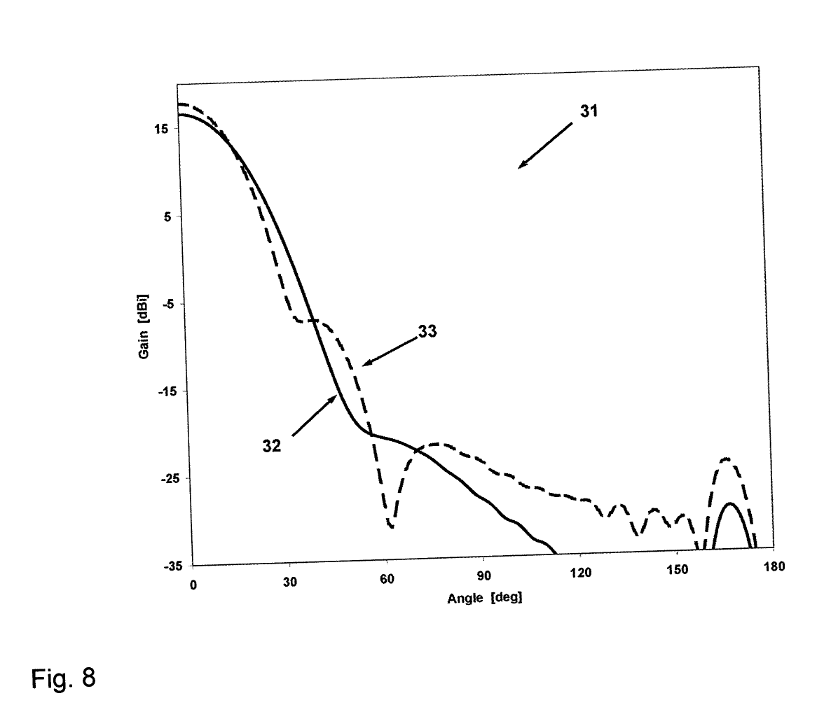

Advantages of the present invention with respect to the conventional radially-corrugated horn will be demonstrated on a like-for-like comparison of horns designed for the same operating frequency bands (20.2-21.2 GHz and 30.0-31.0 GHz): both horns have the same input waveguide diameter (11.2 mm), the same electrical aperture diameter (27.3 mm) and the same aperture-edge illumination tapers at 41 degrees (14.8 dB at 20.2 GHz and 25.3 dB at 30.0 GHz), whereby the aperture-edge illumination taper at 41 degrees is the difference between the horn power gain at 0 degrees and 41 degrees, referring to the far-field radiation pattern plots 21 and 31 in FIGS. 7 and 8, respectively, as it would be obvious to anyone having ordinary skill in the art.

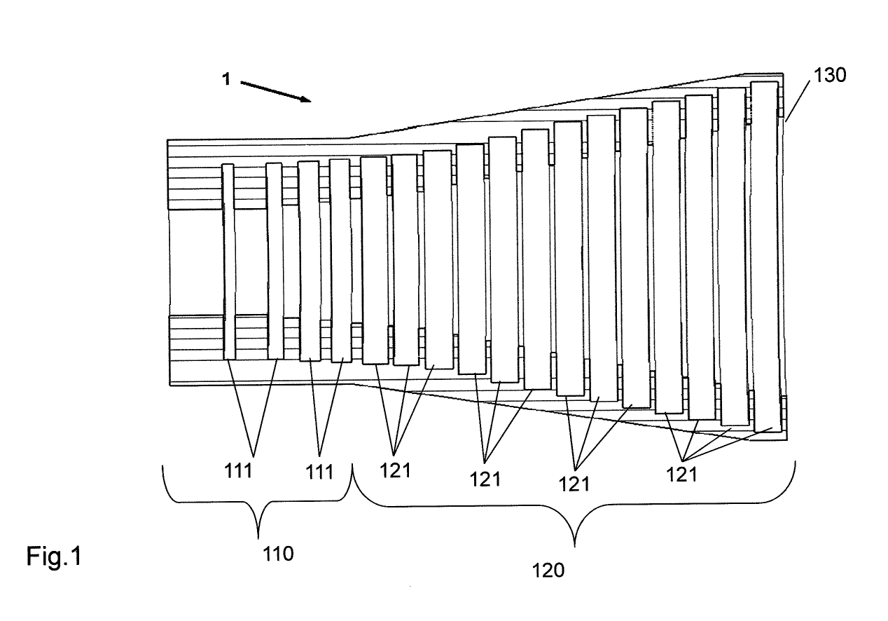

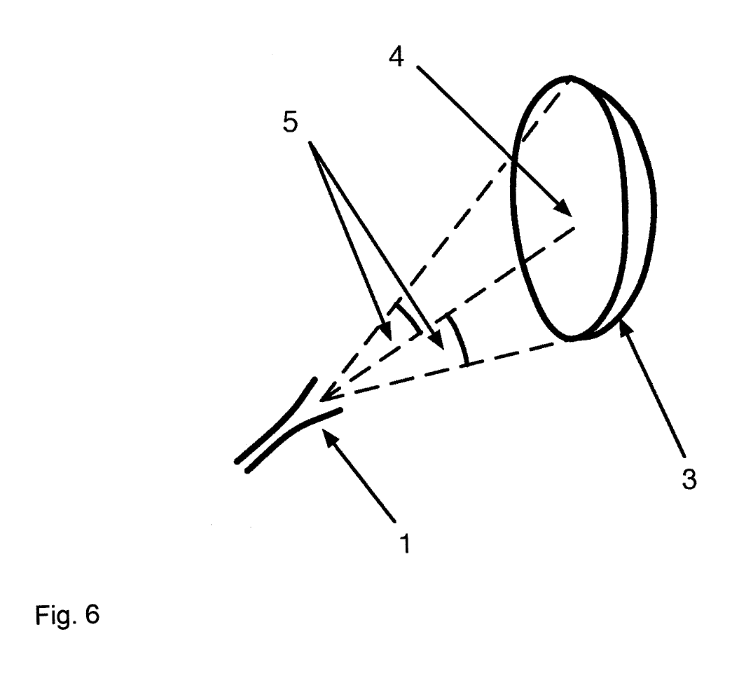

Referring to FIG. 7, there is shown the far-field radiation pattern plot 21 of co-polarized radiation 23 of the conventional corrugated horn of FIG. 1 at 20.2 GHz and co-polarized radiation 22 of the exemplary corrugated horn in accordance with the principles of the present invention of FIGS. 3 and 4 at 20.2 GHz. When the horns are used to illuminate a circular aperture 4 with a conical half-angle 5 of 41 degrees, such as that of a reflector 3 in FIG. 6, the radiation patterns of the two horns are substantially identical: both horns yield the same power gain (14.24 dBi) at 0 degrees, the same aperture-edge illumination taper (14.8 dB) at 41 degrees and radiate the same amount of co-polarized power toward the aperture, whereby the amount of radiated co-polarized power is proportional to the respective areas, in the 0-41 degree angular range, under the radiation pattern plots 22 and 23.

Referring to FIG. 8, there is shown the far-field radiation pattern plot 31 of co-polarized radiation 33 of the conventional corrugated horn of FIG. 1 at 30.0 GHz and co-polarized radiation 32 of the exemplary corrugated horn in accordance with the principles of the present invention of FIGS. 3 and 4 at 30.0 GHz. When the horns are used to illuminate a circular aperture 4 with a conical half-angle 5 of 41 degrees, such as that of a reflector 3 in FIG. 6, both horns yield the same aperture-edge illumination taper (25.3 dB). The power gain (16.56 dBi) at 0 degrees of the exemplary corrugated horn in accordance with the principles of the present invention is actually lower than that (17.77 dBi) of the conventional corrugated horn, meaning the exemplary corrugated horn in accordance with the principles of the present invention has a lower aperture efficiency than the conventional corrugated horn. However, the area from 0 to 41 degrees under the radiation pattern plot 32 (upon gain conversion from dB's to absolute values) of the exemplary corrugated horn in accordance with the principles of the present invention is by 18 percent larger than the area from 0 to 41 degrees under the radiation pattern plot 33 (upon gain conversion from dB's to absolute values) of the conventional corrugated horn. This means a circular aperture 4 with a conical half-angle 5 of 41 degrees, such as that of a reflector 3 in FIG. 6, captures more co-polarized power when illuminated by the exemplary corrugated horn in accordance with the principles of the present invention than when illuminated by the conventional corrugated horn. The increased co-polarized power captured by the aperture when illuminated by the exemplary corrugated horn in accordance with the principles of the present invention, in turn, translates to a higher peak co-polarized power gain of the illuminated aperture—for example, when the exemplary corrugated horn in accordance with the principles of the present invention of FIGS. 3 and 4 is used to illuminate a displaced-axis Gregorian reflector configuration whose subreflector has the conical half-angle of 41 degrees and the main reflector has the diameter of 1 m, the peak co-polarized power gain of the antenna system is by 0.7 dB higher than when the same displaced-axis Gregorian reflector configuration is illuminated by the conventional corrugated horn of FIG. 1. It is in this end effect of providing a higher secondary-pattern peak power gain while maintaining a desired secondary-pattern sidelobe control where the principal utility of the present invention rests.

Although the effect of increased captured co-polarized power when an aperture is illuminated by the preferred embodiment of the present invention has been demonstrated in only one of the two bands that the preferred embodiment of the present invention was designed for, it is to be understood that the disclosure has been made by way of example only and that the present invention is not limited to the effect of increased captured co-polarized power in one band only; rather the effect of increased captured co-polarized power can be achieved in one or more frequency bands, and the amount of increased captured co-polarized power in the frequency bands can be controlled and balanced one against another with proper tuning of the horn profile.

In order to re-emphasize the principal differences between the prior-art patents and the present invention, the Kung et al. and Parrikar et al. references disclose corrugated horns with higher aperture efficiency—therefore also higher power gain at 0 degrees—so as to respectively achieve a flat-top beam and lower sidelobes of secondary radiation patterns produced by the reflector configuration that the corrugated horns illuminate. In contrast, the present invention describes a corrugated horn with a higher amount of co-polarized power radiated within the solid angle of the cone subtended by the illuminated reflector configuration in order to achieve a higher power gain at 0 degrees of the reflector configuration (i.e., a higher power gain at 0 degrees of the secondary radiation pattern), not that of the horn itself. As is shown in the far-field radiation pattern plot 31 of FIG. 8, the present horn itself has a lower power gain at 0 degrees than the conventional corrugated horn.

As a matter of fact, the desired effect that the present invention yields is achieved partly by reducing the power gain of the horn at 0 degrees, whereby part of the co-polarized power that the conventional corrugated horn radiates in the vicinity of 0 degrees is in the present invention redistributed further away from 0 degrees, closer to the imaginary surface of the cone subtended by the illuminated aperture, as the far-field radiation pattern plot 31 of FIG. 8 shows. A second contribution to the desired effect may come from redistributing the power from co-polarized far-out sidelobes of the conventional corrugated horn to the angular range of the cone subtended by the illuminated aperture—that effect is also apparent in the far-field radiation pattern plot 31 of FIG. 8.

While the conventional corrugated horn achieves remarkably low cross-polarization (with the maximum of cross-polarized radiation 40 dB plus below the maximum of co-polarized radiation), this level of polarization purity is not always necessary in practical applications. In the present invention, the suppression of cross-polarized radiation in the designed-for operating frequency bands can be balanced as needed and traded against the desired effect of increasing the co-polarized power radiated within the solid angle of a cone.

It is also noteworthy the present invention allows to reduce the drift of the phase-center position over the operating frequency band(s). For example, while the phase center of the conventional corrugated horn of FIG. 1 delimits the locus of 8.6 mm in overall length (2.5-3.1 mm and 10.2-11.1 mm behind the horn aperture in the 20.2-21.2 GHz and 30.0-31.0 GHz bands, respectively), the phase center of the exemplary corrugated horn in accordance with the principles of the present invention of FIGS. 3 and 4 delimits the locus of only 2.6 mm in overall length (1.1-2.3 mm behind the horn aperture in the 20.2-21.2 GHz band and 0.5 mm behind to 0.3 mm in front of the horn aperture in the 30.0-31.0 GHz band). The shorter length of the locus, in turn, reduces the degree of antenna performance compromise that must be made in determining one optimal feed location—i.e., the overall least-damaging amount of defocusing—in the reflector/lens system that the horn illuminates, such as that shown in FIG. 6.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A feed horn for transmitting and receiving signals, comprising:
a throat section structured to convert a TE₁₁ mode to an HE₁₁ mode;
an aperture section positioned opposite the throat section;
a multiple-corrugation transition section connected to the throat section and having a plurality of radial corrugations that substantially widen an interior of the feed horn from the throat section toward the aperture section; and
the throat section, the aperture section and the transition section being arranged to have a same axis of symmetry,
wherein the plurality of corrugations are dimensioned relative to one another to alter a mode content of a signal so that a more co-polarized power is radiated within a predetermined solid angle of a cone in at least one frequency band as compared to a reference feed horn employing a substantially pure HE_{I 1} mode in its aperture and providing a same illumination taper at a same conical half-angle at same frequencies.

2. The feed horn according to claim 1, further comprising an input-impedance matching section coupled between a feed horn input and a feeding waveguide.

3. The feed horn according to claim 2, wherein the input-impedance matching section is structured to match an input impedance of the feed horn through non-reflective direct signal propagation in the at least one operating frequency band.

4. The feed horn according to claim 1 being structured to be free of bound states of electromagnetic energy within the at least one operating frequency band.

5. The feed horn according to claim 1, wherein an overall locus of phase center positions over the at least one operating frequency band spans a shorter distance than that of the reference feed horn employing the substantially pure HE₁₁ mode in its aperture.

6. The feed horn according claim 1 being structured and arranged to produce low cross-polarization in the at least one operating frequency band.

7. The feed horn according to claim 1, wherein the interior of the feed horn has a generally step-wise contour.

8. The feed horn according to claim 1, wherein the interior of the feed horn flares outwardly from the throat section to the aperture section in a generally step-wise manner.

9. The feed horn according to claim 1, wherein widths of a plurality of the corrugations in the direction of the symmetry axis are dissimilar.

10. A method for forming a feed horn comprising:
connecting a multiple-corrugation transition section to a throat section and to an aperture section positioned opposite the throat section, the multiple-corrugation transition section having a plurality of radial corrugations that substantially widen an interior of the feed horn from the throat section toward the aperture section,
dimensioning the corrugations of the multiple-corrugation transition section relative to one another to alter a mode content of a signal so that the formed feed horn radiates more co-polarized power within a predetermined solid angle of a cone in at least one frequency band as compared to a reference feed horn employing a substantially pure HE₁₁ mode in its aperture and providing a same illumination taper at a same conical half-angle at the same frequencies.

11. The method according to claim 10, structuring the feed horn to be free of bound states of electromagnetic energy within the at least one operating frequency band.

12. The method according to claim 10, structuring the feed horn so that an overall locus of phase center positions over the at least one operating frequency band spans a shorter distance than that of the reference feed horn employing the substantially pure HE₁₁ mode in its aperture.

13. The method according to claim 10, structuring the feed horn to produce low cross-polarization in the at least one operating frequency band.

14. The method according to claim 10, wherein the interior of the feed horn is shaped with a generally step-wise contour.

15. The method according to claim 10, wherein the interior of the feed horn is shaped to flare outwardly from the throat section to the aperture section in a generally step-wise manner.

16. The method according to claim 10, wherein the throat section is structured for converting a TE₁₁ mode to an HE₁₁ mode.

17. The method according to claim 10, wherein widths of a plurality of the corrugations in the direction of the symmetry axis are formed to be dissimilar.
